(19) United States
(12) Patent Application Publication
(10) Pub. No.: US 2026/0127492 A1
(43) Pub. Date: May 7, 2026

(54) DATA PROCESSING SYSTEM AND MODEL OPTIMIZATION METHOD

(71) Applicant: MEDIATEK INC., Hsinchu City (TW)

(72) Inventors: Ping-Hsun Hsieh, Hsinchu City (TW); Wei-Liang Kuo, Hsinchu City (TW); Ming-Yu Hung, Hsinchu City (TW)

(21) Appl. No.: 19/270,531

(22) Filed: Jul. 16, 2025

Related U.S. Application Data
(60) Provisional application No. 63/715,673, filed on Nov. 4, 2024.

(51) Int. Cl. G06N 20/00; G06F 11/34

(52) U.S. Cl. CPC G06N 20/00; G06F 11/3466

(57) ABSTRACT

A data processing system, which performs a model optimization for a first model executed on a platform, comprises a first processing unit and a second processing unit. The first processing unit is configured to capture a set of statistical data of the first model on the platform, and to generate trace data based on the statistical data, wherein the trace data indicates a plurality of performance metrics of the first model. The second processing unit is configured to execute a second model to analyze the performance metrics indicated by the trace data to generate an advice data for the first model. The advice data comprises a suggestion for optimizing the first model and/or a bottleneck identification for indicating a bottleneck of performance of the first model.

This application claims the benefit of U.S. provisional application Ser. No. 63/715,673, filed Nov. 4, 2024, the disclosure of which is incorporated by reference herein in its entirety.

### TECHNICAL FIELD

The disclosure relates to a model optimization mechanism, and particularly relates to a data processing system and a model optimization method for a target model executed on a platform.

### BACKGROUND

For evaluating a performance of a target model, a toolset named “profiling system” is often utilized. The profiling system may perform a “performance profiling” for the target model, which may collect trace data of a computational model according to statistical data of the computational model when the computational model is executed on a hardware platform, and the trace data indicates various performance metrics. After the profiling system collects the trace data, researchers need to manually analyze the trace data to identify bottlenecks and inefficiencies of the target model, and further provide suggestions for optimizing the target model. The whole process may cause a huge timing cost. Furthermore, the bottlenecks of the target model cannot be precisely identified with manual efforts by the researchers.

In view of the above issues, it is desirable to have an improved model optimization mechanism, which can automatically and precisely analyze trace data of the computational model in order to identify the bottlenecks of the target model precisely.

### SUMMARY

According to one embodiment of the present disclosure, a data processing system is provided. The data processing system is for performing a model optimization for a first model which is executed on a platform, and the data processing system comprises a first processing unit and a second processing unit. The first processing unit is configured to capture a set of statistical data of the first model on the platform, and to generate trace data based on the statistical data, wherein the trace data indicates a plurality of performance metrics of the first model. The second processing unit is configured to execute a second model to analyze the performance metrics indicated by the trace data to generate an advice data for the first model. The advice data comprises a suggestion for optimizing the first model and/or a bottleneck identification for indicating a bottleneck of performance of the first model.

According to another embodiment of the present disclosure, a model optimization method is provided. The model optimization method is for a first model which is executed on a platform, and the model optimization method comprises the following steps. A set of statistical data of the first model on the platform are captured. Trace data is generated based on the statistical data, wherein the trace data indicates a plurality of performance metrics of the first model. A second model is executed to analyze the performance metrics indicated by the trace data to generate an advice data for the first model. The advice data comprises a suggestion for optimizing the first model and/or a bottleneck identification for indicating a bottleneck of performance of the first model.

### BRIEF DESCRIPTION OF THE DRAWINGS

FIG. 1 is a block diagram of a data processing system according to an embodiment of the present disclosure.

FIG. 2 is a schematic diagram of the visual data.

FIG. 3 is a block diagram of the first processing unit.

FIG. 4 is a block diagram of the second processing unit.

FIG. 5 is a flow diagram of a model optimization method according to an embodiment of the present disclosure.

FIG. 6 is a flow diagram of a model optimization method according to still another embodiment of the present disclosure.

FIG. 7 is a flow diagram of a model optimization method according to yet another embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

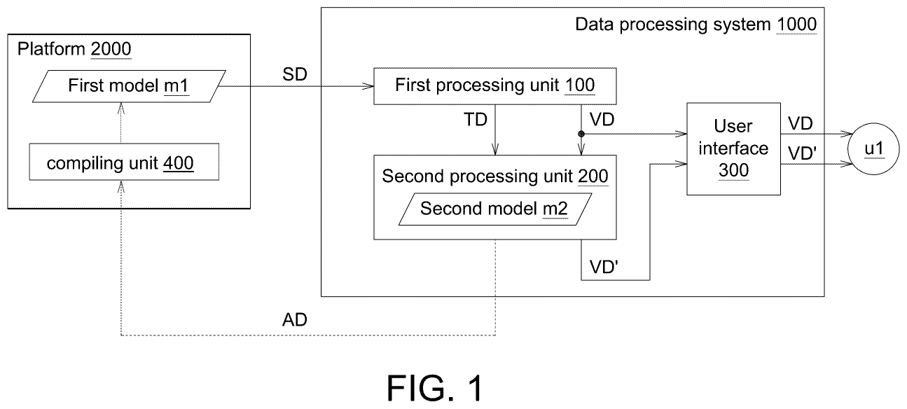

Referring to FIG. 1, which is a block diagram of a data processing system 1000 according to an embodiment of the present disclosure. The data processing system 1000 is used to perform a model optimization for a first model m1. The first model m1 is referred to as a “target model”, which may be any type of computational model, e.g., a convolutional neural network (CNN) model. The first model m1 is deployed and executed on a platform 2000, and the platform 2000 is a hardware device. For example, the platform 2000 may be a portable or fixed hardware device, e.g., a smart phone, a wearable device, a panel computer, a laptop computer or a desktop computer. The platform 2000 has hardware resources, e.g., computing cores, memory devices, and communication bandwidth, etc. When executed on the platform 2000, the first model m1 may utilize these hardware resources, and the first model m1 may have a performance related to utilization of the hardware resources.

The data processing system 1000 functions as a “profiling system” for the first model m1. The data processing system 1000 may identify a bottleneck of the performance of the first model m1 when the first model m1 is executed on the platform 2000. Furthermore, the data processing system 1000 may provide a suggestion for optimizing the performance of the first model m1 on the platform 2000. In the embodiment of FIG. 1, the data processing system 1000 is separated from the platform 2000. Alternatively, the data processing system 1000 may be integrated in the platform 2000. The data processing system 1000 is a hardware processor, e.g., a central processing unit (CPU), a graphics processing unit (GPU), a digital signal processor (DSP) or a micro control unit (MCU). Alternatively, the data processing system 1000 may be a hardware circuit in the form of an integrated circuit (IC) or a system circuit fabricated on a printed circuit board (PCB).

The data processing system 1000 includes a first processing unit 100 and a second processing unit 200. In some embodiments, each of the first processing unit 100 and the second processing unit 200 is a hardware element in the data processing system 1000. For example, when the data processing system 1000 is a CPU, each of the first processing unit 100 and the second processing unit 200 may be a processing unit of the CPU. Alternatively, when the data processing system 1000 is a system circuit on a PCB, each of the first processing unit 100 and the second processing unit 200 may be an IC or a circuitry component inside the data processing system 1000. In other embodiments, the first processing unit 100 and the second processing unit 200 may be two software modules executed on a hardware element, such as, any hardware element of those (CPU, IC and circuitry component) mentioned above.

The first processing unit 100 is operatively coupled to the platform 2000. When the first model m1 is executed on the platform 2000, the first processing unit 100 is configured to capture a set of statistical data SD of the first model m1 when the first model m1 is executed, and to generate trace data TD based on the statistical data SD. Table 1 shows some contents of an example of the trace data TD, and each value in Table 1 may be a statistical data SD.

TABLE 1

| | | | | Core | Core | Flow | | |
|---|---|---|---|---|---|---|---|---|
| Fuse | Layer | Conv | Dram | 0 | 1 | execution | MultiCore | Preload |
| Group | (Tflite ID) | urate | traffic(MB) | urate | urate | ratio | Policy | Policy |
| 0 | 0, 1, 2, 3 | 20% | 31.7 | 75% | 78% | 5.1% | SMPXY | 0 |
| 1 | 4, 5, 6, 7, | 40% | 44.2 | 80% | 80% | 10.8% | SMPXY | 0 |
| | 8, 9 | | | | | | | |
| 2 | 10, 11, 12 | 32% | 19.3 | 95% | 0% | 20.2% | SMPXY | 1 |
| 3 | 13, 14 | 55% | 34.9 | 90% | 0% | 6.2% | SMPXY | 1 |
| 4 | 15 | 25% | 60.1 | 78% | 90% | 3.3% | SMPOC | 0 |
| 5 | 16, 17, | 45% | 12.2 | 90% | 90% | 23.2% | SMPXY | 1 |
| | 18, 19 | | | | | | | |
| 6 | 20, 21, | 60% | 7.8 | 92% | 90% | 7.1% | SMPXY | 1 |
| | 22 | | | | | | | |
| 7 | 23, 24 | 30% | 40.4 | 80% | 80% | 4.3% | SMPOC | 1 |
| 8 | 25, 26, 27 | 31% | 13.6 | 78% | 75% | 8.2% | SMPXY | 1 |
| 9 | 28 | 22% | 41.0 | 69% | 68% | 12.6% | SMPXY | 0 |

The trace data TD may indicate various performance metrics of the first model m1 when the first model m1 is executed. The performance metrics of the first model m1 may include but not limited: (1) an “execution time” for each layer or operation of the first model m1, (2) a “hardware resource usage” associated with the hardware resources of the platform 2000 which are utilized by the first model m1, e.g., the utilization of compute units, memory bandwidth, and cache, (3) a “power consumption and temperature monitoring” for energy efficiency issue, (4) a “memory access pattern” that indicates accessing-frequency of the memory and may reflect latency issues (e.g., cache misses), and (5) “data transfer statistics” that indicates data-amounts of transferred data between different memory-hierarchies.

More particularly, in table 1, the item “Conv urate” may indicate the convolution engine utilization rate when executing the corresponding Fuse Group (in the first column) and layer(s) (in the second column). The item “Dram traffic” may indicate the DRAM usage when executing the corresponding Fuse Group and layer(s). The item “Core 0 urate” may indicate the utilization rate of Core 0 when executing the corresponding Fuse Group and layer(s). The item “Core 1 urate” may indicate the utilization rate of Core 1 when executing the corresponding Fuse Group and layer(s). The item “Flow execution ratio” may indicate the execution ratio of the corresponding Fuse Group and layer(s) occupying among a whole flow. The item “MultiCore policy” may indicate a strategy for distributing and scheduling tasks across multiple cores (e.g., Core 0, Core 1, Core 2, . . . , etc.) when executing the corresponding Fuse Group and layer(s). In the column of “MultiCore Policy”, the term “SMPXY” may represent a symmetric multi-processing policy, while the term “SMPOC” may represent another optimized multi-core scheduling policy to assign the corresponding Fuse Group and layer(s) to a single core. The item “Preload Policy” may describe whether and how relevant data or model parameters are preloaded into a memory or cache before the execution the corresponding Fuse Group and layer(s), in order to reduce waiting time and latency during execution. If the “Preload Policy” has a content of “1” or “Yes”, it means the data will be preloaded into a memory before the task starts. On the other hand, If the content of the “Preload Policy” is “O” or “No”, it means no preloading will be performed, and data will be loaded only when needed.

In one example, the trace data TD is obtained based on the statistical data SD when the first model m1 is executed in a real-execution environment (i.e., the first model m1 is executed on the platform 2000). In another example, the trace data TD is obtained based on the statistical data SD when the first model m1 is executed in a simulation environment.

In some embodiments, the first processing unit 100 is configured to convert the trace data TD into a visual data VD. The visual data VD is referred to as a “trace snapshot” which is a visualization graph of the trace data TD.

In one example, the data processing system 1000 may further include a user interface 300. The user interface 300 is configured to provide the visual data VD to a user u1. The user interface 300 may demonstrate the trace data TD and/or visual data VD to the user u1, such that the user u1 may easily observe and monitor the performance metrics of the first model m1.

In one example, the platform 2000 may further include a compiling unit 400 for processing the first model m1. More particularly, the compiling unit 400 may re-compile the first model m1 based on an advice data AD. The compiling unit 400 may receive the advice data AD from the second processing unit 200 of the data processing system 1000, where the advice data AD may include a bottleneck identification and/or a suggestion for the compiling unit 400 to re-compile the first model m1. After the re-compiling process, the first model m1 is tuned and then re-executed in the platform 2000.

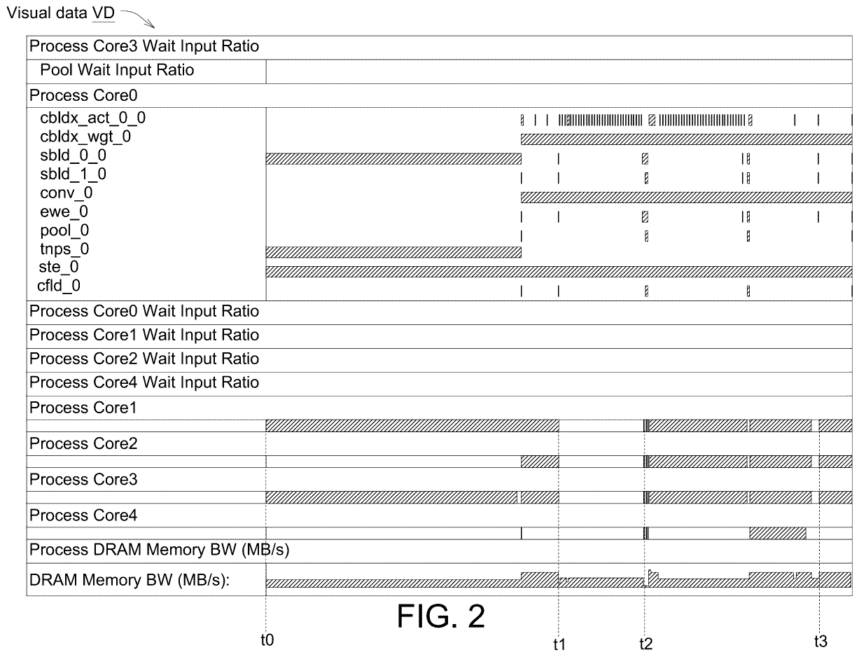

Now, please refer to FIG. 2, which is an example of the visual data VD. The visual data VD includes a visualization graph which may reflect partial or whole contents in the trace data TD. In this example, the visual data VD shows utilization of several process cores and DRAM memory during a specific period (for example, a period from a time point t0 to a time point t3) of the execution of the first model m1. According to FIG. 2, it indicates that only Core 0 of the platform 2000 is used while other Cores 1-4 of the platform 2000 are idle in a period from the time point t1 to the time point t2.

Now, please refer back to FIG. 1, the first processing unit 100 provides the trace data TD and/or the visual data VD to the second processing unit 200. The second processing unit 200 is configured to analyze the performance metrics of the first model m1, which are represented by the trace data TD and/or the visual data VD. More particularly, the second processing unit 200 is configured to execute a second model m2 to perform artificial intelligence (AI) algorithms to analyze the performance metrics of the first model m1. In one example, the second model m2 may be any type of large language model (LLM). Based on the analytical results on the performance metrics by the second model m2, the second processing unit 200 is configured to generate the advice data AD for the first model m1. As afore-mentioned, the advice data AD may include the bottleneck identification of the performance of the first model m1 and/or the suggestion for optimizing the performance of the first model m1.

The bottleneck identification may indicate the bottleneck of the performance of the first model m1 when executed on the platform 2000. For example, the bottleneck identification may indicate layers of first model m1 with excessive execution times, memory access issues, or under-utilization of hardware resources of the platform 2000. Furthermore, the suggestion may provide specific actions for optimizing the first model m1. Some exemplary suggested actions are: modifying the model architecture of the first model m1, adjusting memory allocation of the platform 2000, and changing parallelization strategies for operating the first model m1.

In one example, the second processing unit 200 may execute the second model m2 (e.g., an LLM) to perform artificial intelligence (AI) algorithms to analyze the performance metrics of the first model m1 indicated by Table 1. After the analysis performed by the second model m2, it is found that in Table 1 the item “Dram traffic” for the Fuse Group numbered “4” may not be enough (i.e., 60.1 MB), and the item “Dram traffic” for the Fuse Group numbered “6” seems very low (i.e., 7.8 MB), thus, the second processing unit 200 adjusts memory allocation of the platform 2000 to optimize the usage of the DRAM.

In another example, AI algorithms may be performed by the second model m2 in the second processing unit 200 to analyze the performance metrics of the first model m1 indicated by FIG. 2. If the analysis result shows that only Core 0 of the platform 2000 is used while other Cores 1-4 of the platform 2000 are idle in the period from the time point t1 to the time point t2, the second processing unit 200 may adjust parallelization strategies of the Cores 0-4 of the platform 2000 to optimize the usage of the Cores 0-4. For example, the second processing unit 200 or the platform 2000 may change the item “Multicore policy” in Table 1 from SMPOC to SMPXY, so as to distribute a task (such as a Fuse Group) to more Cores to increase processing efficiency.

In some embodiments, the second processing unit 200 is configured to mark contents of the advice data AD in the visual data VD, so as to form a marked visual data VD′. That is, contents of the advice data AD (i.e., bottleneck identification and suggestions) may be marked or highlighted in the visual data VD to form the marked visual data VD′. The marked visual data VD′ may also be demonstrated to the user u1 through the user interface 300, such that the user u1 may easily realize the bottleneck identification and suggestions for the first model m1 through the marked visual data VD′.

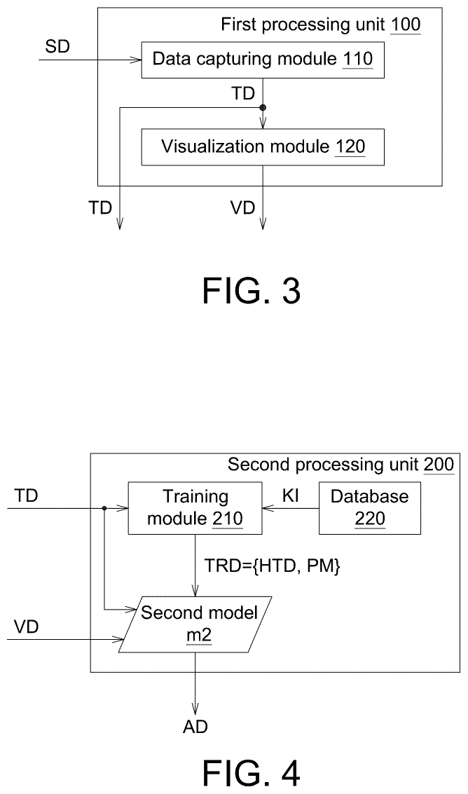

More details of circuitry structures and operations of the first processing unit 100 and the second processing unit 200 will be described in the following paragraphs by reference to FIGS. 3 and 4.

FIG. 3 is a block diagram of the first processing unit 100. As shown in FIG. 3, the first processing unit 100 includes a data capturing module 110 and a visualization module 120. In operation, the data capturing module 110 functions to capture the set of statistical data SD of the first model m1 when the first model m1 is executed, and generate trace data TD based on the statistical data SD. As mentioned before, the trace data TD may indicate various performance metrics of the first model m1 when the first model m1 is executed. Some examples of the trace data TD and the performance metrics of the first model m1 are provided above and are omitted here for the sake of brevity.

Furthermore, the data capturing module 110 provides the trace data TD to the visualization module 120. The visualization module 120 is configured to perform graphic processing to plot the visualization graph for contents of the trace data TD, which forms the “trace snapshot” thereof (as the examples in FIG. 2).

FIG. 4 is a block diagram of the second processing unit 200. As shown in FIG. 4, the second processing unit 200 includes a training module 210, a database 220 and the second model m2. The training module 210 is configured to receive the trace data TD from the data capturing module 110 of the first processing unit 100. More particularly, the trace data TD obtained by the training module 210 may be at least one historical trace data HTD, which refers to the trace data for the first model m1 when executed on the platform 2000 during historical periods. Furthermore, the training module 210 is configured to provide the at least one historical trace data HTD as a first portion of a training data TRD. The training data TRD will be used to train the second model m2, in a training phase of the second model m2.

Moreover, the training module 210 is configured to provide a prompt PM as a second portion of a training data TRD. The prompt PM is adjusted to have a structure suitable for training the second model m2. The training module 210 generates the prompt PM based on a key information KI, and such a key information may be obtained from the database 220. The key information KI contains a relationship between the at least one historical trace data HTD and performance metrics of the first model m1.

More particularly, the key information KI may include the following contents: (1) “hardware resource balancing”, which regards activity time of each process core shown in the trace data TD, so as to confirm that all process cores are engaged evenly in computations, (2) “utilization rate (uRate) analysis”, which regards utilization metrics of each process core, so as to determine the under-utilized resource, (3) “key performance Indicator (KPI)”, which regards measured latency or throughput with baselines, so as to determine the processing speed of the first model m1, (4) “memory access amount”, which regards the read/write volume and unnecessary data transfer which slows down computing speed of the first model m1, detects whether the bandwidth usage is close to a limitation of hardware resource, and observes the utilization of different levels of memory hierarchy (e.g., the L1/L2 caches, or the DDR memory), and (5) “multi-dimensional data cross analysis”, which identifies whether performance issues are caused by the shortage of a single hardware resource or the lack of coordination among multiple hardware resources.

Subsequent to the training phase, the second model m2 may enter an execution phase in which the second model m2 is deployed to perform real execution. In the execution phase, the second model m2 is executed by the second processing unit 200 to analyze the performance metrics of the first model m1, which are represented by the trace data TD and/or the visual data VD.

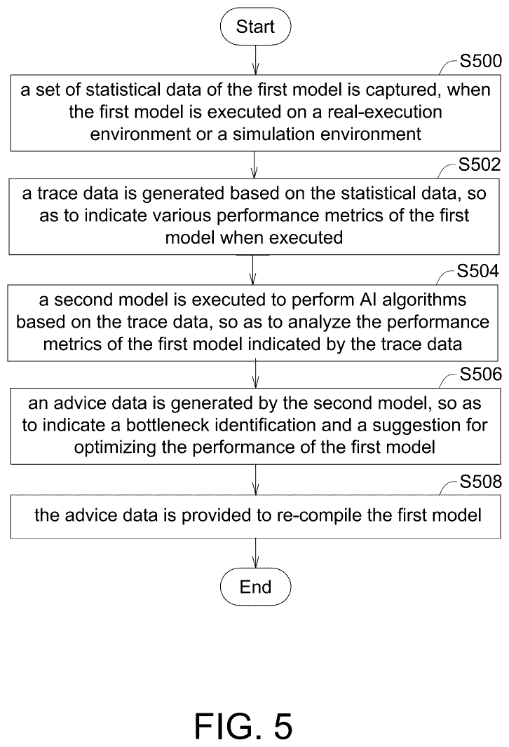

FIG. 5 is a flow diagram of a model optimization method according to an embodiment of the present disclosure. The model optimization method of this embodiment may be implemented by the data processing system 1000 of FIG. 1. Referring to FIG. 5, firstly, a step S500 is executed: a set of statistical data SD of the first model m1 is captured by the first processing unit 100 of the data processing system 1000, when the first model m1 is executed on the platform 2000 of a real-execution environment (or alternatively, when the first model m1 is executed in a simulation environment other than the platform 2000).

Next, a step S502 is executed: trace data TD is generated by the first processing unit 100, based on the statistical data SD. The trace data TD indicates various performance metrics of the first model m1 when the first model m1 is executed on the platform 2000. Next, a step S504 is executed: a second model m2 is executed by a second processing unit 200 of the data processing system 1000 to perform AI algorithms based on the trace data TD, so as to analyze the performance metrics of the first model m1 which are indicated by the trace data TD. The second model m2 may be any type of LLM.

Next, a step S506 is executed: an advice data AD is generated by the second model m2 in the second processing unit 200. The advice data AD includes a bottleneck identification of the performance of the first model m1 and/or a suggestion for optimizing the performance of the first model m1. Next, an optional step S508 is executed: the advice data AD is provided to a compiling unit 400 of the platform 2000, and the first model m1 is re-compiled based on the advice data AD.

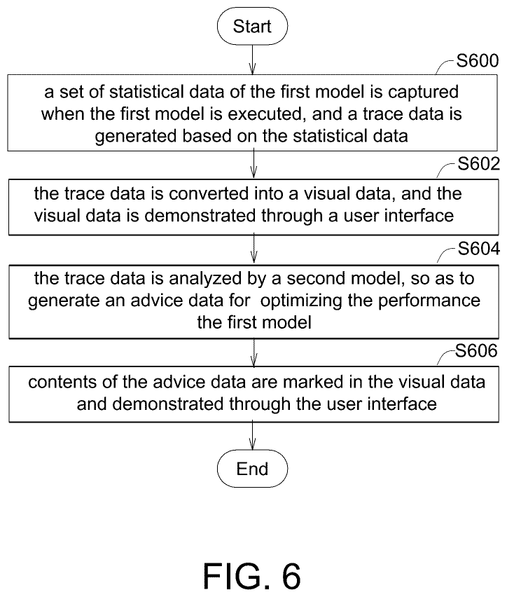

FIG. 6 is a flow diagram of a model optimization method according to another embodiment of the present disclosure. Referring to FIG. 6, firstly, a step S600 is executed: a set of statistical data SD of the first model m1 is captured by the data capturing module 110 (as shown in FIG. 3) the first processing unit 100 of the data processing system 1000, when the first model m1 is executed on a real-executed platform 2000 or in a simulation environment. Furthermore, trace data TD is generated by the first processing unit 100 based on the statistical data SD. The actions in the step S600 in FIG. 6 may correspond to the actions in steps S500 and S502 in FIG. 5.

Next, a step S602 is executed: the trace data TD is converted into a visual data VD by the visualization module 120 (as shown in FIG. 3) of the first processing unit 100. Furthermore, the visual data VD is demonstrated through a user interface 300 of the data processing system 1000. The trace data TD and/or the visual data VD indicate various performance metrics of the first model m1 when the first model m1 is executed on the platform 2000.

Next, a step S604 is executed: the performance metrics of the first model m1 indicated by the trace data TD and/or the visual data VD is analyzed by the second model m2 using AI algorithms, so as to generate an advice data AD. The actions in the step S604 in FIG. 6 may correspond to the actions in steps S504 and S506 in FIG. 5. Next, an optional step S606 is executed: contents of the advice data AD are marked in the visual data VD by the visualization module 120, and demonstrated through the user interface 300.

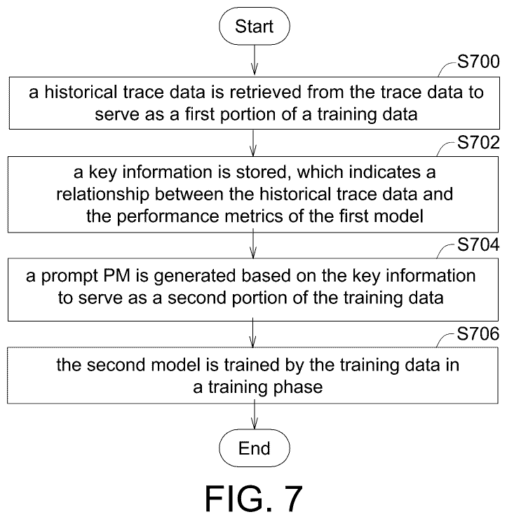

FIG. 7 is a flow diagram of a model optimization method according to yet another embodiment of the present disclosure. Referring to FIG. 7, firstly, a step S700 is executed: a historical trace data HTD is retrieved from the trace data TD, by a training module 210 (shown in FIG. 4) of the second processing unit 200, and the historical trace data HTD serves as a first portion of a training data TRD. Next, a step S702 is executed: a key information KI is stored in a database 220 (shown in FIG. 4) of the second processing unit 200. The key information KI indicates a relationship between the historical trace data HTD and the performance metrics of the first model m1.

Next, a step S704 is executed: a prompt PM is generated by the training module 210, based on the key information KI. The prompt PM serves as a second portion of the training data TRD. Next, a step S706 is executed: the second model m2 is trained by the training module 210 in a training phase, based on the training data TRD.

In one example, after the second model m2 is trained in the training phase (as executed in the step 706), the second model m2 can be executed by the second processing unit 200 in an inferencing phase subsequent to the training phase, so as to analyze the performance metrics of the first model m1 indicated by the trace data TD (as executed in the step S504 in FIG. 5 or the step 604 in FIG. 6).

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A data processing system, for performing a model optimization for a first model which is executed on a platform, the data processing system comprising:
a first processing unit, configured to capture a set of statistical data of the first model, and to generate trace data based on the statistical data, wherein the trace data indicates a plurality of performance metrics of the first model; and
a second processing unit, configured to execute a second model to analyze the performance metrics indicated by the trace data to generate an advice data for the first model,
wherein the advice data comprises a suggestion for optimizing the first model and/or a bottleneck identification for indicating a bottleneck of performance of the first model.

2. The data processing system of claim 1, wherein the second model is a large language model (LLM) and different from the first model.

3. The data processing system of claim 1, wherein the performance metrics comprise an execution time for each layer or operation of the first model, a hardware resource usage associated with the hardware resources of the platform which are utilized by the first model, a power consumption and temperature monitoring for energy efficiency issue, a memory access pattern, and data transfer statistics.

4. The data processing system of claim 1, wherein the first processing unit is further configured to convert the trace data into a visual data which is a visualization graph of the trace data.

5. The data processing system of claim 4, further comprising:
a user interface, configured to demonstrate the visual data.

6. The data processing system of claim 5, wherein the second processing unit is further configured to mark a plurality of contents of the advice data in the visual data, and the user interface is further configured to demonstrate the contents which are marked.

7. The data processing system of claim 1, wherein the second processing unit comprising:
a training module, configured to retrieve a historical trace data and provides the historical trace data as a first portion of a training data, and the training data is used to train the second model in a training phase.

8. The data processing system of claim 7, wherein the second model is executed by the second processing unit in an execution phase subsequent to the training phase to analyze the performance metrics of the first model.

9. The data processing system of claim 7, wherein the second processing unit further comprising:
a database, for storing a key information indicating a relationship between the historical trace data and the performance metrics of the first model.

10. The data processing system of claim 9, wherein the training module is further configured to generate a prompt based on the key information and to provide the prompt as a second portion of the training data.

11. A model optimization method for a first model which is executed on a platform, comprising:
capturing a set of statistical data of the first model on the platform;
generating trace data based on the statistical data, wherein the trace data indicates a plurality of performance metrics of the first model; and
executing a second model to analyze the performance metrics indicated by the trace data to generate an advice data for the first model,
wherein the advice data comprises a suggestion for optimizing the first model and/or a bottleneck identification for indicating a bottleneck of performance of the first model.

12. The model optimization method of claim 11, wherein the second model is a large language model (LLM) and different from the first model.

13. The model optimization method of claim 11, wherein the performance metrics comprise an execution time for each layer or operation of the first model, a hardware resource usage associated with the hardware resources of the platform which are utilized by the first model, a power consumption and temperature monitoring for energy efficiency issue, a memory access pattern, and data transfer statistics.

14. The model optimization method of claim 11, wherein after the step of generating trace data based on the statistical data, further comprising:
converting the trace data into a visual data which is a visualization graph of the trace data.

15. The model optimization method of claim 14, wherein after the step of converting the trace data into the visual data, further comprising:
demonstrating the visual data through a user interface.

16. The model optimization method of claim 15, wherein a plurality of contents of the advice data are marked in the visual data, and the marked contents are demonstrated by the user interface.

17. The model optimization method of claim 11, wherein before the step of executing a second model to analyze the performance metrics indicated by the trace data, further comprising:
retrieving a historical trace data;
providing the historical trace data as a first portion of a training data; and
training the second model in a training phase, by the training data.

18. The model optimization method of claim 17, wherein in the step of executing a second model to analyze the performance metrics indicated by the trace data, the second model is executed in an execution phase subsequent to the training phase.

19. The model optimization method of claim 17, wherein before the step of training the second model in a training phase, further comprising:
storing a key information indicating a relationship between the historical trace data and the performance metrics of the first model.

20. The model optimization method of claim 19, further comprising:
generating a prompt based on the key information; and
providing the prompt as a second portion of the training data.
